(19) United States
(12) Patent Application Publication
(10) Pub. No.: US 2016/0019564 A1
(43) Pub. Date: Jan. 21, 2016

(54) EVALUATING DEVICE READINESS

(71) Applicant: Verizon Patent and Licensing Inc., Basking Ridge, NJ (US)

(72) Inventors: Ye OUYANG, Basking Ridge, NJ (US); Carol BECHT, Boonton, NJ (US); Gopinath VENKATASUBRAMANIAM, Bridgewater, NJ (US); Christopher M. SCHMIDT, Branchburg, NJ (US); Benjamin LOWE, Short Hills, NJ (US)

(73) Assignee: Verizon Patent and Licensing Inc.

(21) Appl. No.: 14/337,057

(22) Filed: Jul. 21, 2014

(51) Int. Cl. G06Q 30/02; G06Q 10/06

(52) U.S. Cl. CPC G06Q 30/0202; G06Q 10/06393; G06Q 10/06315

(57) ABSTRACT

Systems and methods for forecasting device return rates are described. Some implementations include initializing a model representing a device's readiness for market based on one or more key performance indicators (KPIs) of the device, the model being represented by a curve, computing differences between measured value of KPIs of the device and values of KPIs fitted to the curve, identifying an inflection point of the curve based on the computed differences, interpreting the shape of the curve based on the identified inflection point, a readiness index and the curvature of the curve and determining a state of readiness of the device based on the interpreted shape of the curve.

### BACKGROUND

In recent years, mobile device usage has significantly increased. Mobile devices, such as smartphones, are being designed and manufactured at a rapid rate to satisfy customer demand. Organizations, such as wireless network providers, may monitor a device's manufacturing progress to determine whether the device would be available to users based on a particular schedule. Specifically, organizations need to determine whether a device is ready to be launched into a consumer market. However, such organizations are unable to quantitatively identify maturity of device readiness for market launch.

As the foregoing illustrates, a new approach for evaluating device readiness may be desirable.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 illustrates a high-level functional block diagram of an example of a system of networks/devices that provide various communications for mobile stations and support an example of evaluating device quality.

FIG. 2 illustrates an exemplary overall framework that can be used to obtain and store operational parameters related to a mobile device.

FIG. 3 illustrates exemplary incremental learning in an analytics engine.

FIG. 4 illustrates an exemplary interface to define relations between data attributes in the metadata.

FIG. 5 illustrates data sources that can provide data to an extract-transform-load (ETL) module and the analytics engine.

FIG. 6 illustrates an exemplary framework to evaluate device readiness.

FIG. 7 illustrates alteration of different curves by a model computer.

FIG. 8 illustrates exemplary readiness curves associated with different manufacturers.

FIGS. 9 and 10 illustrate exemplary readiness reports that may be displayed via a user interface.

FIG. 11 illustrates a high-level functional block diagram of an exemplary non-touch type mobile station that can be associated with a device quality evaluation service through a network/system like that shown in FIG. 1.

FIG. 12 illustrates a high-level functional block diagram of an exemplary touch screen type mobile station that can be evaluated by the device quality evaluation service through a network/system like that shown in FIG. 1.

FIG. 13 illustrates a simplified functional block diagram of a computer that may be configured as a host or server, for example, to function as the analytics engine in the system of FIG. 1.

FIG. 14 illustrates a simplified functional block diagram of a personal computer or other work station or terminal device.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The implementations disclosed herein can evaluate device readiness or maturity for a pre-launched device and forecast (or trend) the time to market for the pre-launched device. This helps device manufacturers and commercial customers (e.g., wireless network providers) better monitor progress of device development for the pre-launched device. The disclosed implementations construct a novel model to forecast device maturity, which can be applied to other fields such as product maturity, software maturity, application quality maturity, etc. The disclosed implementations provide a generalized model applicable to resolve quality maturity related problems. Furthermore, the implementations can classify original equipment manufacturers (OEMs) based on respective readiness curves associated with devices manufactured by the OEMs. According to classified clusters, OEMs sharing an identical classification can have similar patterns of quality maturity in developing a device. Such classification can help wireless network providers (or other entities) estimate device readiness for a given OEM more accurately as well as rate (or rank) OEMs based on manufacturing performance. In this way, wireless network providers can monitor OEMs during device development. For example, wireless network providers can determine which OEMs are falling behind an agreed upon device delivery schedule. Representatives of the wireless network providers may then contact the OEMs to request an explanation for delays or provide recommendations on how the OEM's may better follow the device delivery schedule. Also, for example, wireless network providers can determine which OEMs are ahead of (or behind) an agreed upon device delivery schedule. In this way, the wireless network providers may determine which OEMs they may choose to work with in the future. The disclosed implementations can provide a neutralized and fair model to identify device readiness. Furthermore, the wireless network providers may leverage the disclosed implementations to estimate device readiness for pre-launched devices from different OEMs. The estimated readiness may be used by the wireless network providers to prepare internal supply chains as well as external services (e.g., advertisers) related to devices that are to be launched.

In some implementations, a model representing a device's readiness for market based on one or more key performance indicators (KPIs) of the device is initialized. The model may be initialized as a sigmoid curve. A sigmoid curve is a mathematical function having an “S” shape. One or more KPI values may be fitted to the curve. Fitting is a process of associating a series of data points to a curve or mathematical function. Then, differences between measured value of KPIs of the device and values of KPIs fitted to the curve may be computed. An inflection point of the curve can be identified based on the computed differences. The inflection point represents a point on the curve at which a derivative representing a curvature of the curve changes sign. The shape of the curve is interpreted based on the identified inflection point, a readiness index and the curvature of the curve, where the device readiness index is based at least on a KPI that takes the most amount of time relative to other KPIs to cross a manufacturing performance threshold represented in the curve. Then, a state of readiness of the device is determined based on the interpreted shape of the curve. The state of readiness of the device can represent a state of readiness for launch to a consumer market.

The disclosed implementations can further provide a report describing the determined state of readiness of the device. The report may include a graphical representation of the curve, a readiness index and KPIs considered in determining a state of readiness of the device. For example, the report may include an indication of whether the state of readiness of the device is above-par, sub-par or on-par relative to pre-determined (or acceptable) state of readiness at a particular time in a manufacturing cycle. The report may also include a performance classification of a manufacturer of the device that can be determined based on the interpreted shape of the curve. Exemplary performance classifications (e.g., early bird, night owl, etc.) are discussed further below.

In some implementations, the report may be used to modify aspects related to a manufacturing and/or supply chain. For example, when the determined readiness of the device is lower than an acceptable level of readiness at a particular time in the manufacturing cycle, then the manufacturer of the device may be notified and take actions needed to expedite integration of components of the device during manufacturing or expeditiously resolve device related issues. In this way, because readiness of a device can be determined before the device is launched to market (or made available for public use or sale in a geographic region), the manufacturer can take pre-emptive actions to address issues with the device so that the device may be launched to the market in based on schedule that may be provided to the manufacturer by a wireless network provider.

Reference now is made in detail to the examples illustrated in the accompanying drawings and discussed below.

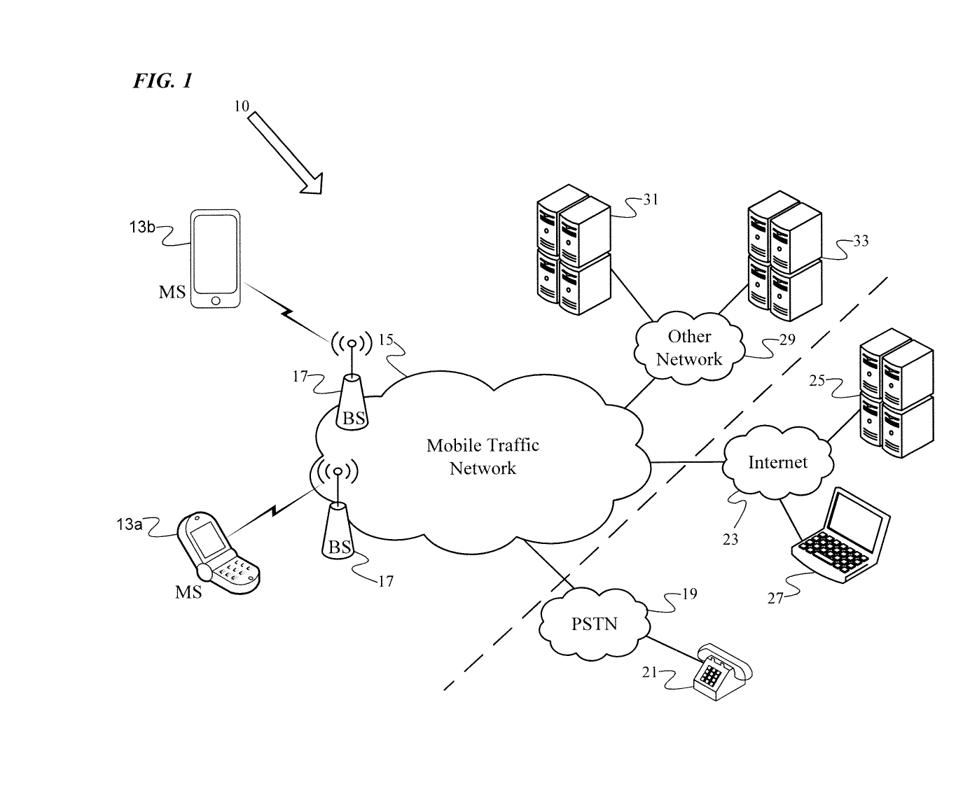

FIG. 1 illustrates a system 10 offering a variety of mobile communication services, including communications for evaluating device readiness. The example shows simply two mobile stations (MSs) 13a and 13b as well as a mobile communication network 15. The stations 13a and 13b are examples of mobile stations for which device readiness may be evaluated. However, the network will provide similar communications for many other similar users as well as for mobile devices/users that do not participate in methods for evaluating device readiness. The network 15 provides mobile wireless communications services to those stations as well as to other mobile stations (not shown), for example, via a number of base stations (BSs) 17. The present techniques may be implemented in any of a variety of available mobile networks 15 and/or on any type of mobile station compatible with such a network 15, and the drawing shows only a very simplified example of a few relevant elements of the network 15 for purposes of discussion here.

The wireless mobile communication network 15 might be implemented as a network conforming to the code division multiple access (CDMA) IS-95 standard, the 3rd Generation Partnership Project 2 (3GPP2) wireless IP network standard or the Evolution Data Optimized (EVDO) standard, the Global System for Mobile (GSM) communication standard, a time division multiple access (TDMA) standard or other standards used for public mobile wireless communications. The mobile stations 13 may are capable of voice telephone communications through the network 15, and for methods to evaluate device readiness, the exemplary devices 13a and 13b are capable of data communications through the particular type of network 15 (and the users thereof typically will have subscribed to data service through the network).

The network 15 allows users of the mobile stations such as 13a and 13b (and other mobile stations not shown) to initiate and receive telephone calls to each other as well as through the public switched telephone network or “PSTN” 19 and telephone stations 21 connected to the PSTN. The network 15 typically offers a variety of data services via the Internet 23, such as downloads, web browsing, email, etc. By way of example, the drawing shows a laptop PC type user terminal 27 as well as a server 25 connected to the Internet 23; and the data services for the mobile stations 13 via the Internet 23 may be with devices like those shown at 25 and 27 as well as with a variety of other types of devices or systems capable of data communications through various interconnected networks. The mobile stations 13a and 13a also can receive and execute applications written in various programming languages, as discussed more later.

Mobile stations 13 can take the form of portable handsets, smart-phones or personal digital assistants, although they may be implemented in other form factors. Program applications, including an application to assist in methods to evaluate device readiness can be configured to execute on many different types of mobile stations 13. For example, a mobile station application can be written to execute on a binary runtime environment for mobile (BREW-based) mobile station, a Windows Mobile based mobile station, Android, I-Phone, Java Mobile, or RIM based mobile station such as a BlackBerry or the like. Some of these types of devices can employ a multi-tasking operating system.

The mobile communication network 10 can be implemented by a number of interconnected networks. Hence, the overall network 10 may include a number of radio access networks (RANs), as well as regional ground networks interconnecting a number of RANs and a wide area network (WAN) interconnecting the regional ground networks to core network elements. A regional portion of the network 10, such as those serving mobile stations 13, can include one or more RANs and a regional circuit and/or packet switched network and associated signaling network facilities.

Physical elements of a RAN operated by one of the mobile service providers or carriers, include a number of base stations represented in the example by the base stations (BSs) 17. Although not separately shown, such a base station 17 can include a base transceiver system (BTS), which can communicate via an antennae system at the site of base station and over the airlink with one or more of the mobile stations 13, when the mobile stations are within range. Each base station can include a BTS coupled to several antennae mounted on a radio tower within a coverage area often referred to as a “cell.” The BTS is the part of the radio network that sends and receives RF signals to/from the mobile stations 13 that are served by the base station 17.

The radio access networks can also include a traffic network represented generally by the cloud at 15, which carries the user communications and data for the mobile stations 13 between the base stations 17 and other elements with or through which the mobile stations communicate. The network can also include other elements that support functionality other than device-to-device media transfer services such as messaging service messages and voice communications. Specific elements of the network 15 for carrying the voice and data traffic and for controlling various aspects of the calls or sessions through the network 15 are omitted here form simplicity. It will be understood that the various network elements can communicate with each other and other aspects of the mobile communications network 10 and other networks (e.g., the public switched telephone network (PSTN) and the Internet) either directly or indirectly.

The carrier will also operate a number of systems that provide ancillary functions in support of the communications services and/or application services provided through the network 10, and those elements communicate with other nodes or elements of the network 10 via one or more private IP type packet data networks 29 (sometimes referred to as an Intranet), i.e., a private networks. Generally, such systems are part of or connected for communication via the private network 29. A person skilled in the art, however, would recognize that systems outside of the private network could serve the same functions as well. Examples of such systems, in this case operated by the network service provider as part of the overall network 10, which communicate through the intranet type network 29, include one or more application servers 31 and a related authentication server 33 for the application service of server 31.

A mobile station 13 communicates over the air with a base station 17 and through the traffic network 15 for various voice and data communications, e.g. through the Internet 23 with a server 25 and/or with application servers 31. If the mobile service carrier provides a service for evaluating device readiness for market, the service may be hosted on a carrier-operated application server 31. The application server 31 may communicate via the networks 15 and 29. Alternatively, the evaluation of device readiness for market may be determined by a separate entity (alone or through agreements with the carrier), in which case, the service may be hosted on an application server such as server 25 connected for communication via the networks 15 and 23. Server such as 25 and 31 may provide any of a variety of common application or service functions in support of or in addition to an application program running on the mobile station 13. However, for purposes of further discussion, we will focus on functions thereof in support of evaluating device readiness for market. For a given service, including the evaluating device readiness for market, an application program within the mobile station may be considered as a ‘client’ and the programming at 25 or 31 may be considered as the ‘server’ application for the particular service.

To insure that the application service offered by server 31 is available to only authorized devices/users, the provider of the application service also deploys an authentication server 33. The authentication server 33 could be a separate physical server as shown, or authentication server 33 could be implemented as another program module running on the same hardware platform as the server application 31. Essentially, when the server application (server 31 in our example) receives a service request from a client application on a mobile station 13, the server application provides appropriate information to the authentication server 33 to allow server application 33 to authenticate the mobile station 13 as outlined herein. Upon successful authentication, the server 33 informs the server application 31, which in turn provides access to the service via data communication through the various communication elements (e.g. 29, 15 and 17) of the network 10. A similar authentication function may be provided for evaluating device readiness offered via the server 25, either by the server 33 if there is an appropriate arrangement between the carrier and the operator of server 24, by a program on the server 25 or via a separate authentication server (not shown) connected to the Internet 23.

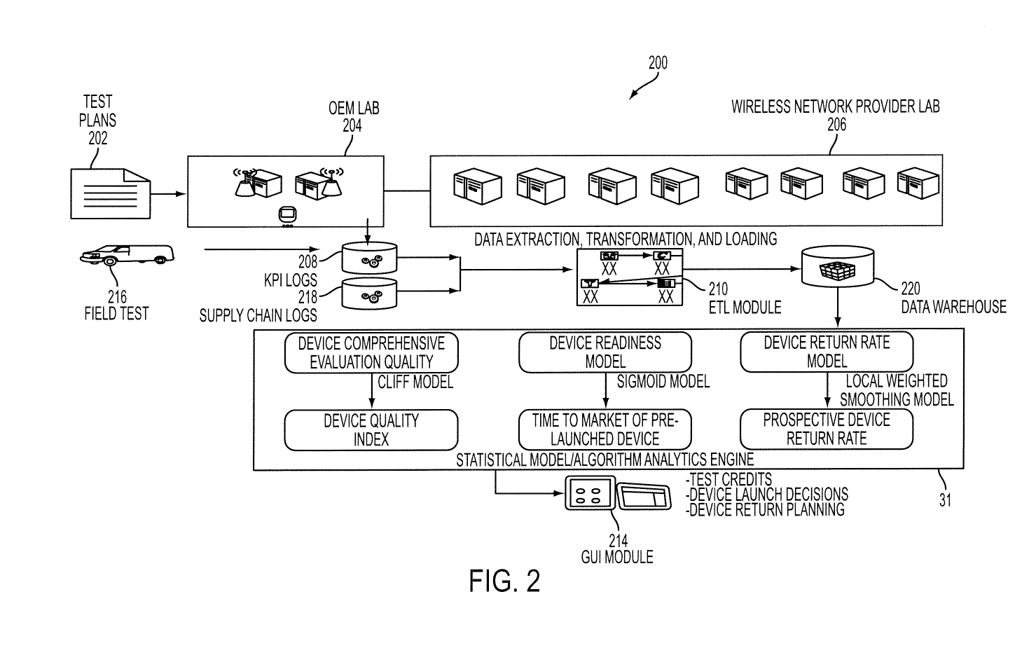

FIG. 2 illustrates an exemplary overall framework 200 that can be used to obtain and store operational parameters related to the mobile station 13a. FIG. 2 illustrates test plans 202, original equipment manufacturer (OEM) lab 204, wireless network provider lab 206, online business database management (KPI) logs 208, Extract-Transform-Load (ETL) module 210, analytics engine 31 and graphical user interface module (GUI) module 214, field tester 216 and data warehouse 220.

In some implementations, the framework of FIG. 2 may be implemented by at least one organization, such as a wireless network provider. In this example, the wireless network provider may operate the framework 200 to determine the quality of mobile devices that have been manufactured by certain manufacturers for customers of the wireless network provider. In other implementations, the framework 200 may be implemented by any other organization or company to evaluate quality of any device. In other words, the framework 200 is not limited to wireless network providers and mobile devices. Furthermore, it is to be appreciated that one or more components illustrated in FIG. 2 may be combined. Operations performed by one or more components may also be distributed across other components.

With reference to FIG. 2 and in some implementations, test plans 202 may include, but are not limited to, data and associated guidelines on how to test the mobile station 13a (or any other device) for quality. The test plans may include machine-readable instructions as well as human-readable instructions. For example, the test plans may be read by a human tester or may be provided to a processor-based computer to perform one or more tests on the mobile station 13a. Such a test may be performed by a processor-based computer to determine certain operational parameters and/or key performance indicators of the mobile station 13a. In some examples, testing of the mobile station 13a may be performed at OEM lab 204. The OEM lab 204 may be a testing facility that is operated by a manufacturer of the mobile station 13a. The OEM lab 204 may be operated by one or more human testers and may include one or more testing stations and testing computers. The devices that are tested at the OEM lab 204 may be designed by a wireless network provider and manufactured by the OEM. The OEM may provide tested prototypes of the mobile station 13a prior to the launch of the mobile station 13a. The tested prototypes may meet particular quality or performance thresholds that may have been provided by the wireless network provider to the OEM. The test plans discussed above may include such quality or performance thresholds. The wireless network provider lab 206 may be a testing facility similar to the OEM lab 204 but may be operated by a wireless network provider that provides network services for the mobile station 13a. The wireless network provider lab 206 may communicate with the components (e.g. analytics engine 31) illustrated in FIG. 1. Simply stated, one purpose of the OEM lab 204 and wireless network provider lab 206 can be to perform one or more tests or measurements on the mobile station 13a to determine operational parameters associated with the mobile station 13a. The measurements can be provided to the analytics engine 31. It is to be appreciated that the implementations are not limited to a single mobile station 13a, but can operate to test and evaluate any number of mobile stations in sequence or in parallel.

In some implementations, KPI logs 208 may include, but are not limited to, data from field tester 216 and OEM lab 204. The field tester 216 may test the mobile station 13a in actual situations reflecting a real-world use of the mobile station 13a. KPI logs 208 may also include data from wireless network provider lab 206. As discussed above, data from OEM lab 204 and the wireless network provider lab 206 can include, but are not limited to, operational parameters associated with the mobile station 13a. In some implementations, the data from the KPI logs 208 can be retrieved or extracted by the ETL module 210. The ETL module 210 may extract, transform and load transformed data into data warehouse 220. Data transformations may include, but are not limited to, re-formatting of the data into a common or open data format.

In some implementations, ETL module 210 may receive data as data files in a particular data format (e.g., .drm file format). The ETL module 210 may use a schema to extract data attributes from a .drm file, then format the data, transform the data, and finally load or store the data to the data warehouse 220. The data warehouse 220 may also include metadata associated with the data received from the ETL module 210. Metadata can specify properties of data. In this way, the data warehouse 220 may include, but is not limited to, transformed data field tester 216, the OEM lab 204 and the wireless network provider lab 206. The data from the data warehouse 220 may be read by the analytics engine 31 to evaluate quality of the mobile station 13a using the exemplary methods discussed below. In some implementations, data from the data warehouse 220 may be provided by the data warehouse 220 to the analytics engine 31. The metadata in the data warehouse 220 can define data attributes as well as their relations. The metadata may include two types of metadata: performance data attribute and a configuration data attribute. Performance data attributes may include, but are not limited to, device KPI name, device KPI unit, device KPI threshold (max and limit value), wireless network (RF) KPI name, RF KPI unit, RF KPI threshold (max and limit value) etc. Configuration data attributes may include, but are not limited to, device name, OEM name, device type, hardware configuration parameters, software parameters, sales data, returns data (per cause code), etc. Once data attributes are defined in a metadata file, their relations can be defined.

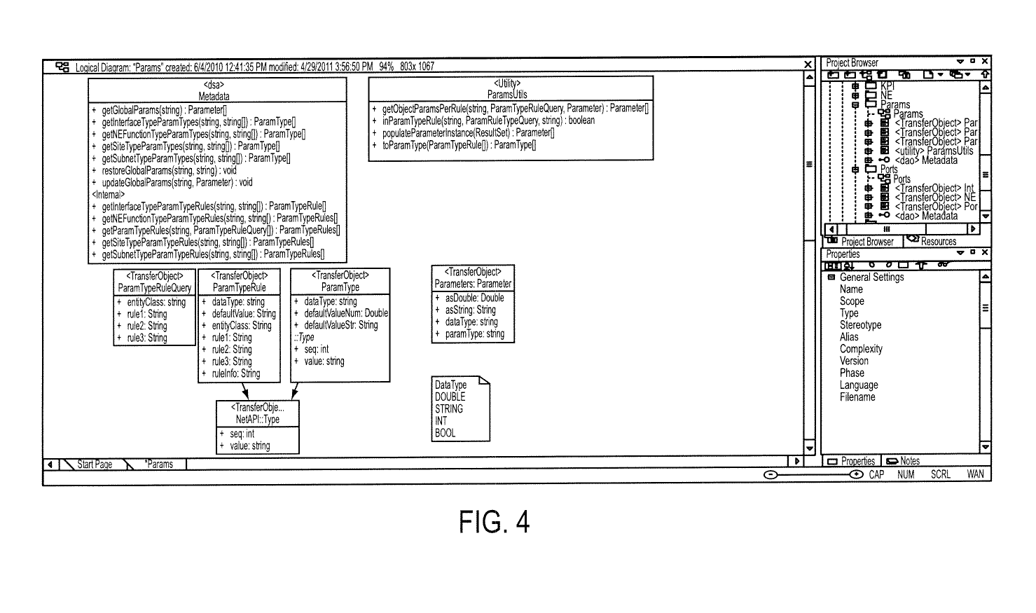

FIG. 4 illustrates an exemplary interface to define the relations between data attributes in the metadata. The interface can be an easy to use web-based interface. For example, a user may use the project browser of the interface to select one or more performance data parameters (e.g., KPIs) and then use logical diagrams to configure mappings between both standard and proprietary data formats. Furthermore, the interface can allow customizing conversion of data types. In addition, a visualization of derived mappings between source and target formats can also be provided.

In some implementations, the analytics engine 31 includes one or more processors, storage and memory to process one or more algorithms and statistical models to evaluate quality of the mobile station 13a. In some implementations, the analytics engine 31 may train and mine the data from ETL module 210. As an example, a training set can be a set of data used to discover potentially predictive relationships. Training sets are used in artificial intelligence, machine learning, genetic programming, intelligent systems, and statistics. A training set can be implemented to build an analytical model, while a test (or validation) set may be used to validate the analytical model that has been built. Data points in the training set may be excluded from the test (validation) set. Usually a dataset is divided into a training set, a validation set (and/or a ‘test set’) in several iterations when creating an analytical model. In this way, for example, the analytics engine 31 may determine models to evaluate device quality. In some implementations, open interfaces (e.g., application programming interfaces (APIs)) may be provided to vendors for reading/writing data between the ETL module 210 and the analytics engine 31 and for visualizing analytics results between the analytics engine 31 and GUI 214. In some implementations, the wireless network provider may provide access to the analytics engine 31 to a third-party vendor.

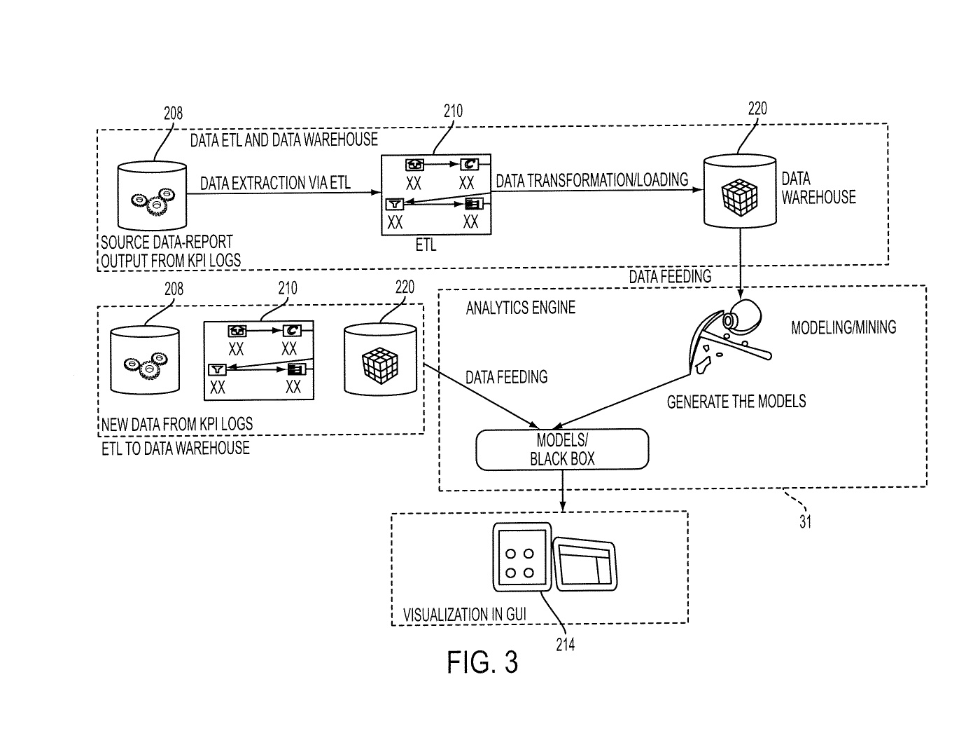

In some implementations, data may be processed incrementally by the analytics engine 31 for instantaneous learning. Incremental learning is a machine learning paradigm where a learning process takes place whenever new example(s) emerge and adjusts what has been learned according to the new example(s). Incremental learning differs from traditional machine learning in that incremental learning may not assume the availability of a sufficient training set before the learning process, the training examples may instead be assumed to appear over time. Based on this paradigm, the algorithms utilized by the analytics engine may be automatically updated by re-training the data processed by the analytics engine 31. In some implementations, a dynamic sliding window method may be used to provide data from the ETL module 210 to the analytics engine 31 for algorithm training by the analytics engine 31. The dynamic sliding window may be used by the ETL module 210 to incrementally provide, for example, operational parameters from the mobile station 13a to the analytics engine 31. For example, and with reference to FIG. 3, the analytics engine 31 may receive data incrementally from ETL module 210 and data warehouse 220 as well as data from an KPI tool or KPI logs 208. The analytics engine 31 can incrementally auto-learn and update algorithms (and related formulae) for mathematical models so that the models conform to latest data received from the ETL module 210.

One or more outputs of the analytics engine 31 may be provided to the GUI 214 for display. As an example, the GUI 214 may be rendered on a mobile device (e.g., tablet computer, smartphone, etc.) that may display data provided by the analytics engine 31. In some implementations, the GUI 214 can be used to visualize analytical results from analytics engine 31. As an example, results from the analytics engine 31 may be visualized as terms of charts, animations, tables and any other form of graphical rendering.

The disclosed implementations can further provide a report describing the determined state of readiness of the device. The report may include a graphical representation of the curve, a readiness index and KPIs considered in determining a state of readiness of the device. For example, the report may include an indication of whether the state of readiness of the device is above-par, sub-par or on-par relative to pre-determined (or acceptable) state of readiness at a particular time in a manufacturing cycle. Recommended states of readiness (provided by a wireless network provider) may be stored at the analytics engine 31. The state of readiness may relate to a particular manufacturing task associated with the mobile station 13a and a time/date at which the task is to be completed. For example, the task may be “Install Touch Screen” and the completion date may be “Jan. 15, 2014.” If on Jan. 15, 2014 the task has not yet been completed the state of readiness of the device can be determined by the analytics engine 31 to be sub-par. If on Jan. 15, 2014 the task is determined to be previously completed, the state of readiness of the device can be determined by the analytics engine 31 to be above-par. If the task is completed on Jan. 15, 2014, the state of readiness of the device can be determined by the analytics engine 31 to be on-par. The report may also include a performance classification of a manufacturer of the device that can be determined based on the interpreted shape of the curve. Exemplary performance classifications (e.g., early bird, night owl, etc.) are discussed further below.

In some implementations, the report may be used to modify aspects related to a manufacturing and/or supply chain. For example, when the determined readiness of the mobile station 13a is lower than an acceptable level of readiness at a particular time in the manufacturing cycle, then the manufacturer of the mobile station 13a may take actions needed to expedite integration of components of the mobile station 13a during manufacturing or expeditiously resolve device related issues. In this way, because readiness of a device can be determined before the mobile station 13a is launched to market, the manufacturer can take pre-emptive actions to address issues with the mobile station 13a so that the mobile station 13a may be released to the market in a timely manner or in a manner that is in accordance with an agreed schedule between a wireless network provider and the manufacturer.

In some implementations, the determined readiness of the mobile station 13a may be used by the analytics engine 31 to automatically alter operation of manufacturing and supply chain components. For example, when a lower than acceptable state of readiness is determined by the analytics engine 31 a robotic arm integrating or soldering components on the mobile station 13a may be instructed by the analytics engine 31 to increase speed or rate of operation to improve the state of readiness to market. In some implementations, a message may be sent automatically from the analytics engine 31 to one or more manufacturing and supply chain components. For example, the analytics engine 31 may instruct a manufacturing and supply chain computer system to re-organize performance of one or more tasks in a manufacturing facility or cancel/suspend other tasks. For example, if the production of the mobile station 13a is running behind a pre-determined schedule, analytics engine 31 may automatically send instructions to a particular component to cancel one or more low priority lasts (e.g., color accents, duplicate logo printing, etc.). Cancellation of such low priority tasks may bring production back on the pre-determined schedule.

In implementations, the readiness report may be automatically transmitted by the analytics engine 31 to one or more computers operated at stores that sell the mobile station 13a to end users. The readiness report may be transmitted to geographically disparate stores around the country and/or world and used by store employees to anticipate when a new device is expected to launch to market. For example, the store employees may use information in the readiness report to prepare the store to handle an influx of customers as well as prepare spaces to handle new inventory. In some implementations, a new readiness report may be transmitted by the analytics engine 31 to the one or more computers at pre-determined intervals (e.g., hourly, daily, weekly, monthly, etc.). The timing for this report may vary, e.g., increasing as the launch date approaches or more frequently with respect to a launch of a device expected to be more desired (e.g., iPhone vs. Blackberry or Windows phone).

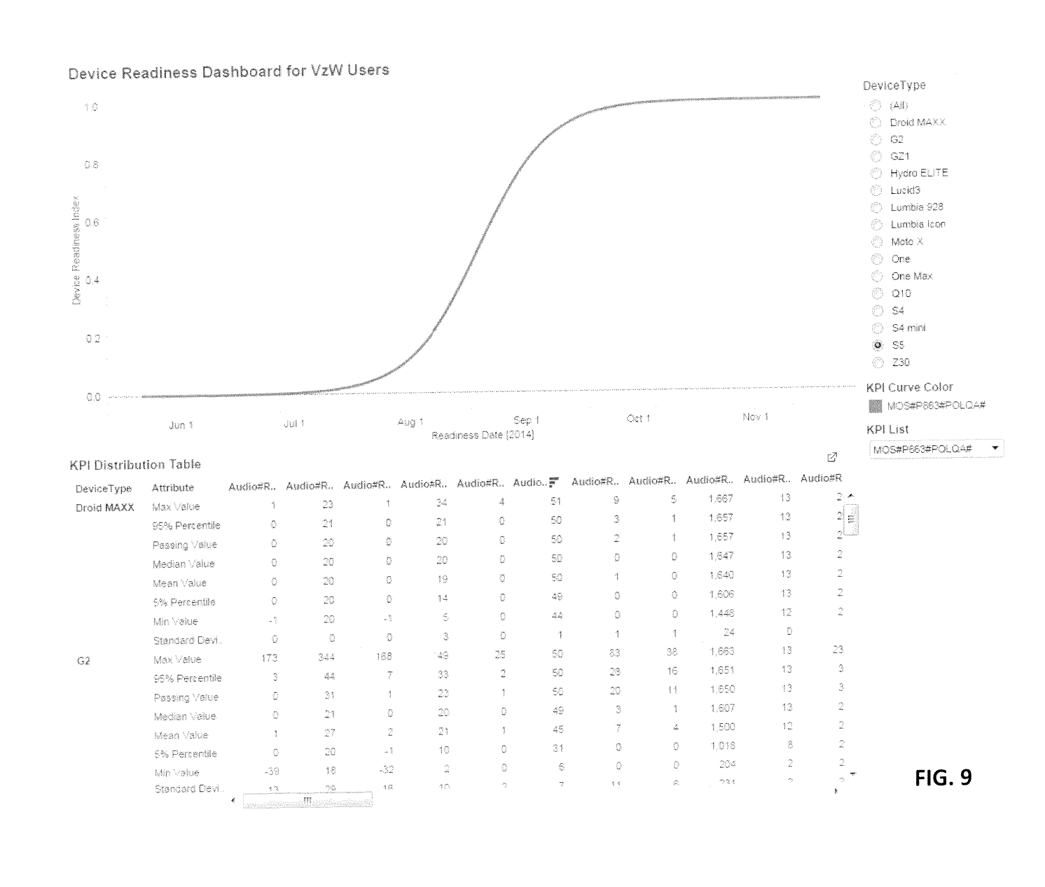

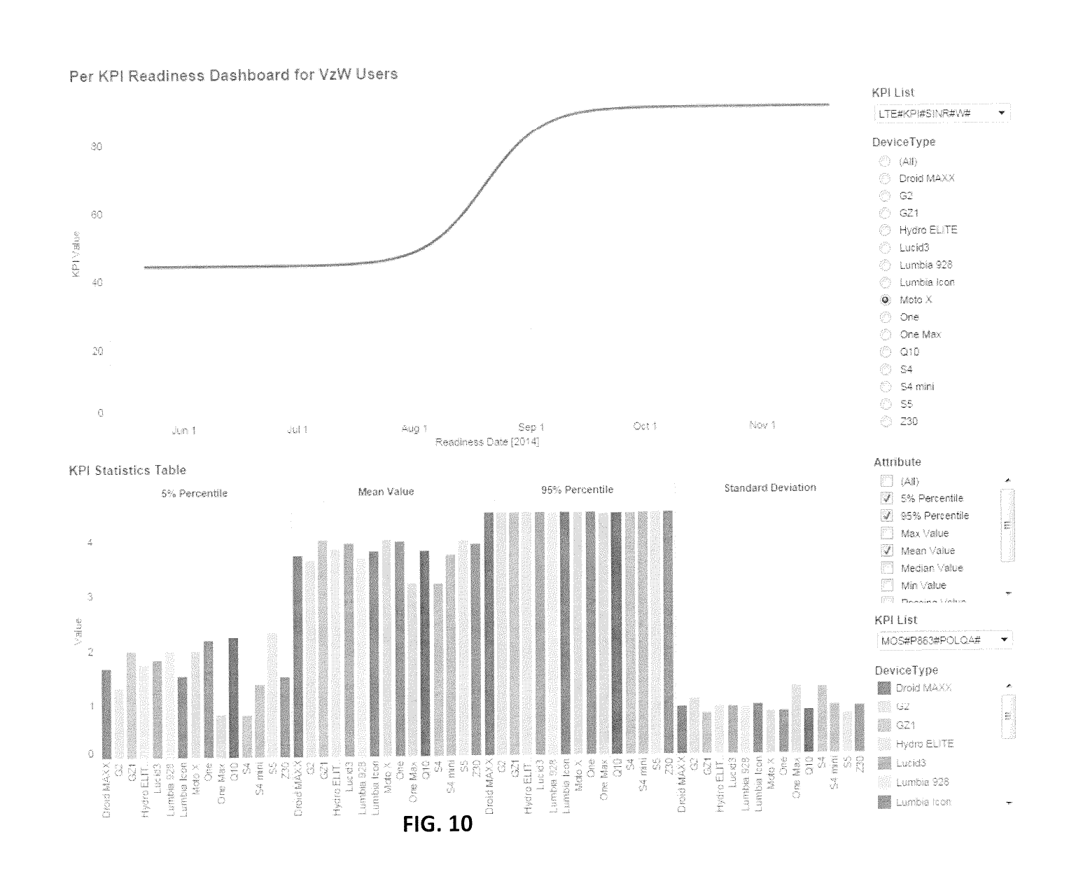

FIGS. 9 and 10 illustrate exemplary readiness reports that may be displayed via a user interface. FIG. 9 illustrates a graphical curve of the device readiness index for the mobile device “S5” when a user selects the mobile device “S5” from the “Device Type” menu. The user can also select the color of the curve using the “KPI Curve Color” menu and also select a particular KPI for the generated curve from the “KPI List.” FIG. 10 illustrates graphical curve of the device readiness index for the mobile device “Moto X” when a user selects the mobile device “Moto X” from the “Device Type” menu. The user can also select the color of the curve using the “KPI Curve Color” menu and also select a particular KPI for the generated curve from the “KPI List.” In addition, FIG. 10 also illustrates a KPI statistics table. The KPI statistics table includes bar graphs associated with different devices (e.g., DroidMax, MotoX, One, etc.). For example, five percentile KPI values, mean KPI values, or a 95 percentile KPI values (as indicated by their respective bar graphs) may be generated and displayed for the different devices. These visualizations can help a representative of wireless network provider to better understand readiness of different devices via a unified interface.

In some implementations, GUI 214 may display a data model, algorithm(s), and inter-component communications. The GUI 214 may include a dashboard based to support multiple applications while providing a unified look and feel across all applications. The GUI 214 may display reports in different formats (e.g., .PDF, .XLS, etc.). The GUI 214 may allow open APIs and objects for creation of custom report(s) by users. The GUI 214 may keep the internal schema for the data warehouse 220 hidden from users and provide GUI features that include, but are not limited to, icons, grouping, icon extensions and administration menu(s). Overall, the GUI 124 can provide a consistent visual look and feel and user friendly navigation.

In some implementations, the analytics engine 31 can be implemented as a device analytics tool. Such a device analytics tool can be, for example, an extension of a KPI monitoring tool to further evaluate device quality for any pre-launched devices. On-board diagnostics can refer to a device's self-diagnostic and reporting capability. KPI tools can give a device tester or repair technician access to status of various device sub-systems. KPI tools can use a standardized digital communications port to provide real-time data. The analytics engine 31 can be a tool to apply statistical modeling algorithms to study device quality, evaluate device readiness, and forecast device return rate etc. More statistical models can be embedded/stored in the analytics engine 31 based on business needs. The analytics engine 31 can allow a device quality team to investigate device quality from several aspects, including, but not limited to, device quality, device readiness and device return rate.

When evaluating device readiness, a sigmoid model can be developed by the analytics engine 31 to forecast the time to market for a given pre-launched device. This model can also be leveraged by the analytics engine 31 to forecast device return rate for a post-launched device. In some implementations, the analytics engine 31 supports the functionality of instantaneous data extraction from a KPI module (e.g., KPI logs 208) as well as instantaneous data transformation and loading. Instantaneous data processing in ETL module 210 can refer to access to KPI data library (e.g., KPI logs 208) for data extraction. Data obtained from the KPI logs 208 may be a quasi-instant step. The ETL module 210 can detect new data that is uploaded to KPI logs 208. The ETL module 210 can perform operations immediately once the new data file is detected in KPI logs 208. Appropriate outlier exclusion approaches may be implemented in the ETL module 210 to exclude and convert outliers, or data that may not conform to known formats, in raw data files. In some implementations, a wireless network provider may provide the outlier detection algorithms to a vendor that provides KPI tools to collect data into KPI logs 208.

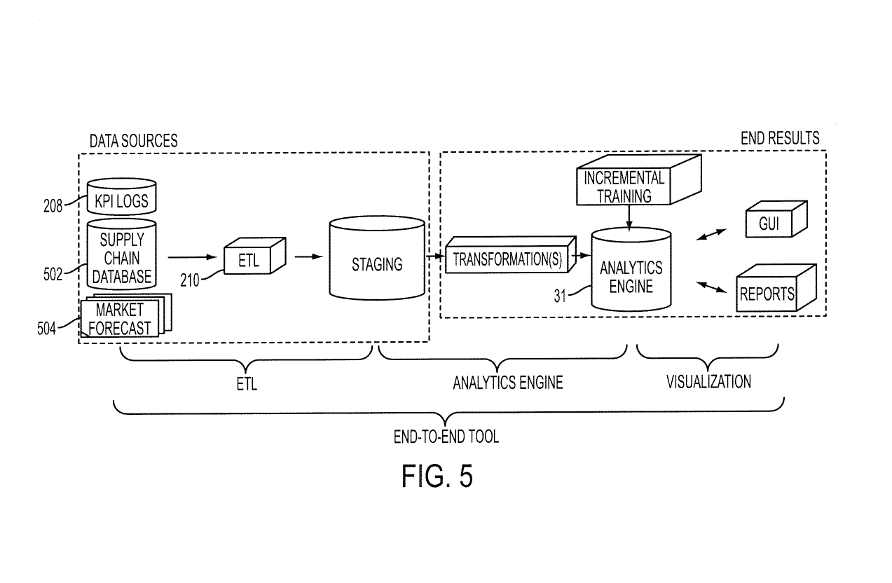

FIG. 5 illustrates different data sources of the analytics engine 31. In some implementations, there can be three primary data sources to ETL module 210 and the analytics engine 31. These data sources include KPI logs 208, supply chain database 502, and market forecast data 504. The KPI logs 208 may be a primary data source to obtain performance data. There can be two data formats available in the KPI logs 208 for the analytics engine 31. One format can be a .DRM format, which can be used to store an original log file uploaded by KPI tool users to a KPI data library. Another format can be a .CSV file, which can be used to store a report generated by a KPI tool. The report can be viewed as a “processed log” via a KPI tool.

Supply chain database 502 can store data related to device rate of return. In some implementations, the wireless network provider can provide device returns data extracted from a supply chain dashboard associated with the supply chain database 502 in a .CSV file. Queries and scripts may be run by ETL module 210 to extract raw data from the supply chain database 502 and save the data as .CSV files. ETL module 210 may accept and feed the data to the analytics engine 31 for further processing.

In implementations, market forecast data 504 can provide the sales data per device per month. This dataset can be merged with the device returns data from the supply chain database 502. Granularity of load-performance data can be seconds, minutes, or busy hour intervals. Returns data and sales data may have granularity of weeks or months.

In some implementations, after data is processed by the ETL module 210 but before the data is passed to staging, a step of outlier exclusion may be implemented by the ETL module 210. In some implementations, an inter-quartile range (IQR) algorithm may be implemented in the ETL module 210 to exclude outliers. In descriptive statistics, the interquartile range, also called the mid-spread or middle fifty, is a measure of statistical dispersion, being equal to the difference between the upper and lower quartiles.

In some implementations, the ETL module 210 can define a unified target file. Each data attribute in metadata can be mapped by the ETL module 210 to a given column in the target file. The target file is generated as the output file by the ETL module 210 and then provided by the ETL module 210 to the analytics engine 31 for further data mining and data processing. This target file can be utilized by the analytics engine 31 for statistical analysis (e.g., statistical analysis of the mobile station 13a). In some implementations, the ETL module 210 may need to split the target file into several files such as a performance file, a configuration file, etc. The target file may be split when the file size is larger than a specified threshold value. The performance file may include data related to performance of hardware (e.g., memory components) and software (e.g., executing applications) of the mobile station 13a. The configuration file may include data associated with certain device settings (e.g., user defined settings) of the mobile station 13a.

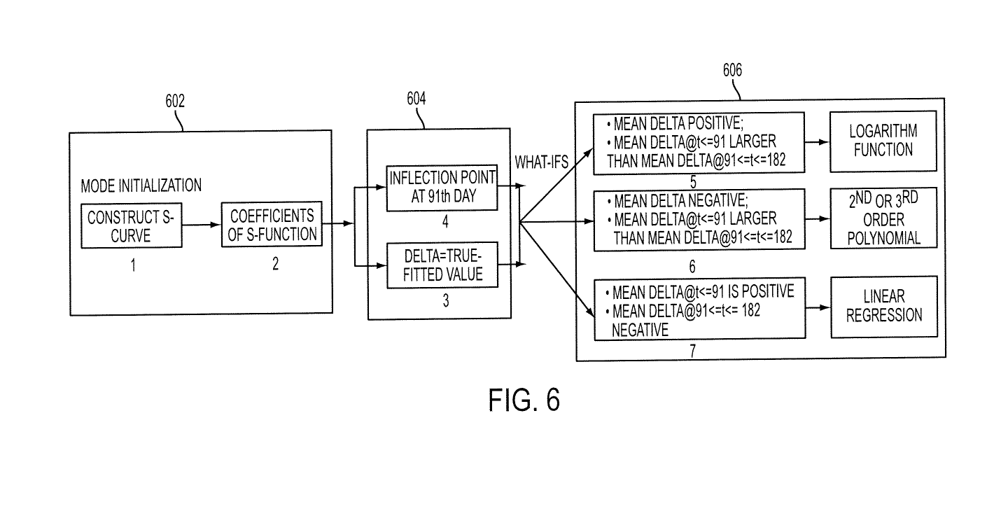

FIG. 6 illustrates an exemplary framework 600 to evaluate device readiness. In some implementations, a model representing a device's readiness for market based on one or more key performance indicators (KPIs) of the device is initialized by model computer 602. The model can be represented by a curve, such as an s-curve or a sigmoid curve. Once the model representing a device's readiness for market is initialized by the model computer 602, the model computer 602 computes coefficients of a sigmoid function (e.g., using a Least Square Method) based on the one or more key performance indicators (KPIs). The Least Square Method is an approach to an approximate solution for sets of equations in which there are more equations than unknowns. “Least squares” indicates that an overall solution minimizes the sum of the squares of the errors made in the results of each equation of the sets of equations.

To initialize the model representing a device's readiness for market, model computer 602 may assume that device readiness presents a sigmoid or s-shape relation to time. As time progresses, more testing data becomes available from the framework of FIG. 2. The model shape may be adjusted by model computer 602 from sigmoid to other shapes. The threshold to change model shape may be triggered by several conditions, including, but not limited to, mean error rate, a determination of whether the curve is concaved up or down, and curve curvature etc.

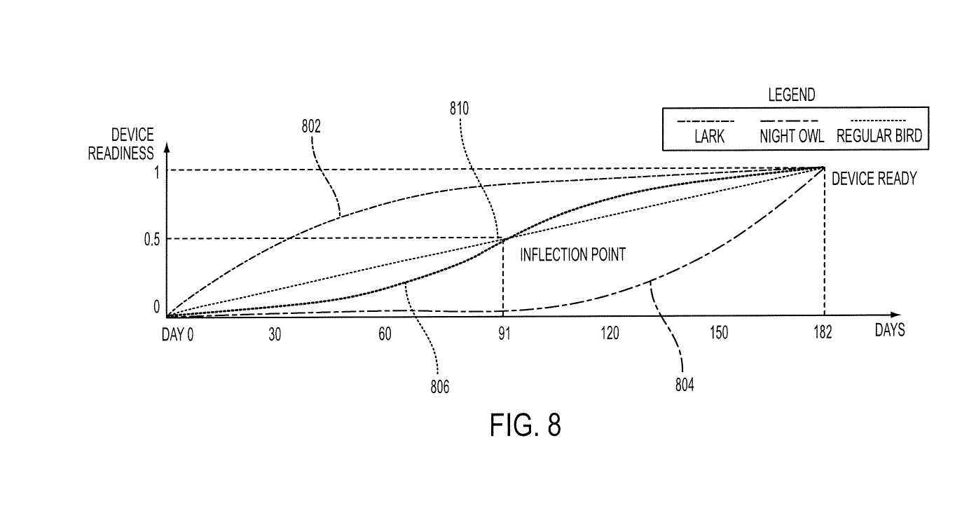

FIG. 8 illustrates exemplary readiness curves 802, 804 and 806 associated with different OEMs. The vertical axis of FIG. 8 indicates DRI values. The horizontal axis is a temporal axis and indicates days in a manufacturing cycle of a device (e.g., the mobile station 13a). Referring again to FIG. 6, an inflection point identifier 604 can compute differences between measured value of KPIs of the device and values of KPIs fitted to the curve. Curve fitting is a process of constructing a curve or mathematical function that has the best fit to a series of data points, possibly subject to constraints. Curve fitting can involve either interpolation, where an exact fit to the data is required, or smoothing, in which a “smooth” function is constructed that approximately fits the data. Inflection point identifier 604 can compute differences between each true value and fitted value (obtained by a sigmoid curve). An inflection point of the curve can be identified by the inflection point identifier 604 based on the computed differences by the inflection point identifier 604. The inflection point represents a point on the curve at which curvature of the curve changes sign. As an illustrative example, the inflection point of an S-curve may be identified as a point corresponding to the 91^{st} day out of 182 day manufacturing cycle of the mobile station 13a. FIG. 8 illustrates exemplary inflection point 810.

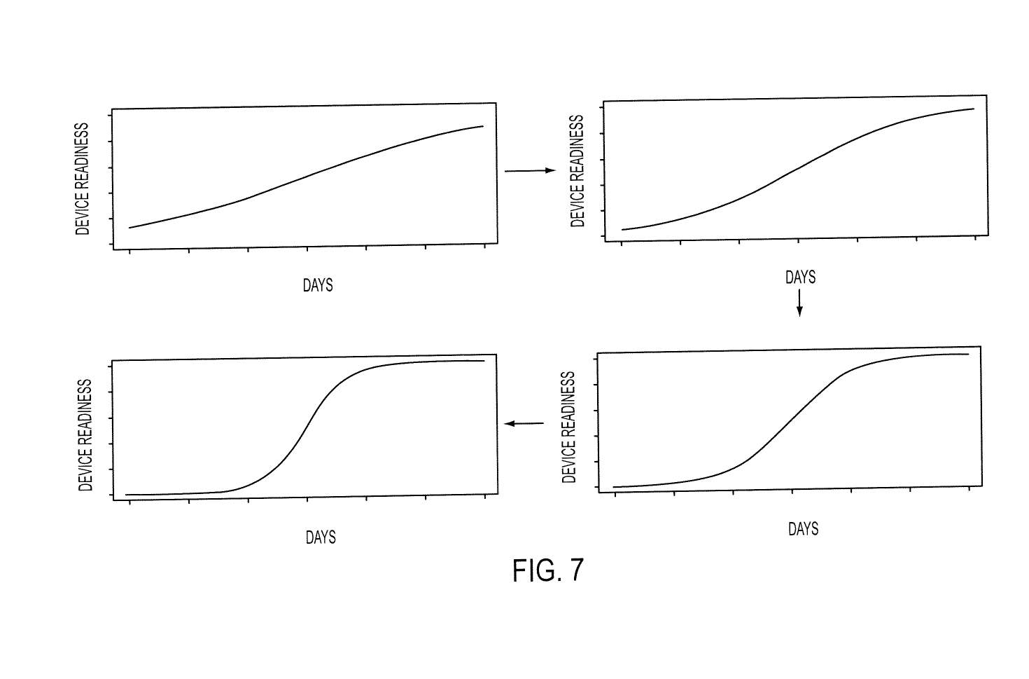

In some implementations, if a mean delta (or difference) of a true value and a fitted value (true minus fitted value) is positive and the mean delta at range t<=91^{st} day is larger than the mean delta at range 92^{nd} day<=t<=182^{nd} day, then the model computer 602 may replace the current sigmoid function with a logarithmic function altering the shape of the initialized curve. Otherwise, if the mean delta of the true value and the fitted value (true minus fitted value) is negative and the mean delta at range t<=91^{st} day is larger than the mean delta at range 92^{nd} day<=t<=192^{nd} day, then the model computer 602 may replace the current initialized sigmoid function with a 2^{nd} or 3^{rd} polynomial function. Furthermore, if the mean delta at range t<=91^{st} day is positive while the mean delta at range 92<=t<=192^{nd} day is negative, then the model computer 602 can determine that the curvature of the initialized sigmoid curve is small and replaces the initialized S-curve with a linear regression function. FIG. 7 illustrates alteration of different curves by the model computer 602 based on a mean delta (or difference) of a true value and a fitted value (true minus fitted value). The curves may be computed to determine a “best” or optimal shape of the curve representing device readiness.

The shape of the curve is interpreted by curve interpreter 606 based on the identified inflection point, a device readiness index and the curvature of the curve. The device readiness index (DRI) is based at least on a KPI for the mobile station 13a that takes the most amount of time relative to other KPIs to cross a manufacturing performance threshold represented in the curve.

If the curve is interpreted to be a concaved downward logarithm curve, the curve interpreter 606 determines that an OEM manufacturing the mobile station 13a prefers fixing manufacturing (or design, software, etc.) issues as soon as the issues materialize. In another scenario, modifications and issues specified by the wireless network provider for resolution can be less complicated and not time consuming for the OEM to fix. Thus, the issues can be fixed by the OEM at an early stage in the manufacturing process of the mobile station 13a. In other words, the OEM is an “early bird” or “lark” and is classified (or clustered) by the curve interpreter 606 with other OEMs sharing similar characteristics. OEMs in such an early bird group may try to resolve manufacturing (or design, software, etc.) issues at early stage in a manufacturing process rather than putting them off till a date close to a market release date of the mobile station 13a. Curve 802 of FIG. 8 illustrates an exemplary “early bird” or “lark” curve that can be associated with an OEM.

If the curve is interpreted to be a 2^{nd} or 3^{rd} order polynomial curve, the curve interpreter 606 determines that an OEM manufacturing the mobile station 13a prefers fixing manufacturing (or design, software, etc.) issues close to cut-off or market release date (e.g., few days or hours before market release). In other words, the OEM is a “night owl” and is classified (or clustered) by the curve interpreter 606 with other OEMs sharing similar characteristics. OEMs in this group may have significant delays and be behind an original schedule proposed by a wireless network provider to whom the mobile station 13a is to be delivered. In another scenario, modifications and issues specified by the wireless network provider can be complicated and time consuming for the OEMs to fix. Thus, the issues cannot be resolved by the OEM until a later stage in the manufacturing process of the mobile station 13a. Curve 804 of FIG. 8 illustrates an exemplary “night owl” curve that can be associated with an OEM.

If the curve is interpreted to be an S-curve or even a linear curve, the curve interpreter 606 determines that an OEM manufacturing the mobile station 13a follows a smooth pattern to conduct the testing work step by step. The progress is neither behind nor ahead of schedule too much. In other words, the OEM is a “regular bird” and is classified (or clustered) by the curve interpreter 606 with other OEMs sharing similar characteristics. OEMs in this group may closely follow an original schedule proposed by a wireless network provider to whom the mobile station 13a is to be delivered. Curve 806 of FIG. 8 illustrates an exemplary “regular bird” curve that can be associated with an OEM.

In some implementations, the model computer 602 may utilize one or more algorithms to determine device readiness based on the interpreted curves discussed above. The determined device readiness may be used to modify aspects related to a manufacturing and/or supply chain. For example, when the determined readiness of the mobile station 13a is lower than an acceptable level of readiness at a particular time in the manufacturing cycle, then the manufacturer of the mobile station 13a may take actions needed to expedite integration of components of the mobile station 13a during manufacturing or expeditiously resolve device related issues. In this way, because readiness of a device can be determined before the mobile station 13a is launched to market, the manufacturer can take pre-emptive actions to address issues with the mobile station 13a so that the mobile station 13a may be released to the market in a timely manner or in a manner that is in accordance with an agreed schedule between a wireless network provider and the manufacturer.

, The model computer 602 may assume that the bench mark value of a given KPI for a device is the measured value at Day 0 (or first day) of the manufacturing cycle of the device (e.g., the mobile station 13a).

Thus, we have:

KPI_{BenchMark}=KPI_{Measured@Day0}

For this particular KPI, the model computer 602 can specify the KPI's acceptance value, which is the threshold to pass this KPI. The KPI acceptance value may be specified by the wireless network provider to the OEM manufacturing the device.

Thus, it can be specified that KPI_{Acceptance}=p

The next step for the model computer 602 is to define a readiness index for a KPI for a device (e.g., the mobile station 13a). The model computer 602 specifies that the readiness index for a KPI at a given day “t” is given by the absolute difference of KPI measured at day t and an absolute difference of a KPI acceptance value and a KPI benchmark. The KPI acceptance value is a KPI value that is acceptable to a wireless network provider to whom the device is to be delivered by the OEM. The KPI benchmark value is a recommended or benchmark KPI value for the particular device. The model computer 602 may compute the DRI as:

$${ReadinessIndex}_{KPI} = \{ \begin{matrix}\vert \frac{{KPI}_{Measured @ Dayt} - {KPI}_{BM}}{{KPI}_{Acceptance} - {KPI}_{BM}} \vert & when {KPI}_{Dayt} \geq {KPI}_{BM} \\ 0 & when {KPI}_{Dayt} < {KPI}_{BM}\end{matrix}$$

In the equation for the device readiness index noted above, KPI_{Dayt}≧KPI_{BM}, indicates that the KPI measured at day t is better than the KPI benchmark value. KPI_{Dayt}≧KPI_{BM}.

After defining DRI, consider a standard sigmoid function, which is represented by:

$$y = f ( x ) = \frac{1}{1 + {e}^{- x}}$$

However, the sigmoid curve of time to market maturity (TTMM) model may not correspond precisely to a standard sigmoid curve. Considering this, a DRI function can be represented as:

$${ReadinessIndex}_{KPI} = f ( t ) = \frac{A \cdot 1}{1 + {e}^{- B \cdot ( t - C )}} = \frac{A}{1 + {e}^{- B \cdot ( t - C )}}$$

In which,

A denotes a maximum value of DRI.

B denotes the curvature of the sigmoid curve. In a circular function, B can be termed as a “phase” of the sigmoid curve; and

C denotes an inflection point of the sigmoid curve.

In the model, if the maximum value of the DRI is known to be 1, we have ReadinessIndex_{Max}=−1. Accordingly, we obtain A=1.

Assuming that the time between when a device is safe for network and when testing is complete is assumed to be 182 days (or 6 months). The inflection point can be determined to be the 91^{st} day.

Thus, we obtain Inflection Point=the 91th day

Accordingly, we have

$${RI}_{KPI} = \frac{1}{1 + {e}^{- B \cdot ( t - 91 )}}$$

Transforming this formula, we get

$$t = 91 - \frac{ln ( \frac{1}{{RI}_{KPI}} - 1 )}{B}$$

Assuming that RI_{KPI}=0, we have

$$t = 91 - \frac{+ ∞}{B} = - ∞ = 0 ,$$

since we do not allow time to be negative. Thus, t=0 when RI_{KPI}=0, it can be interpreted that at day 0 that DRI is also 0.

When the model is initialized by the model computer 602, the model computer 602 assumes, for example, that the testing work performed by the OEM in day 1 completes 1/182 of overall testing work, which is represented by 1/182 of DRI.

Therefore, assuming that

$${RI}_{KPI} = \frac{1}{182} ,$$

we have:

$$t = 91 - \frac{ln ( \frac{1}{1 / 182} - 1 )}{B} = 91 - \frac{5.198}{B}$$

Thus,

$$t = 91 - \frac{5.198}{B} = 1 day$$

Accordingly, it can be determined in this example that B=0.5776

Finally the TTMM model can be represented by the function group below.

$${ReadinessIndex}_{KPI} = \{ \begin{matrix}\vert \frac{{KPI}_{Measured @ Dayt} - {KPI}_{BM}}{{KPI}_{Acceptance} - {KPI}_{BM}} \vert & when {KPI}_{Dayt} \geq {KPI}_{BM} \\ 0 & when {KPI}_{Dayt} < {KPI}_{BM}\end{matrix} \\ {t}_{KPI} = 91 - \frac{ln ( \frac{1}{{RI}_{KPI}} - 1 )}{0.05776} \\ {TimetoMarket}_{KPI} = {Dayx}_{KPI} + ( 182 - {t}_{KPI} )$$

In some implementations, the model computer 602 may perform the following steps to construct the model.

At first, the model computer 602 may compute a DRI value for a particular KPI i.

In a non-limiting implementation, the DRI value for the particular KPI i may be computed as:

for kpi from 1 to i {
get kpi i's benchmark value KPIiBM ;
get kpi i's acceptance value KPIiAcceptance ;
get kpi i's measured value at DayX KPIiMeasured@Dayx ;
if KPIiMeasured@Dayx >= KPIiBM {
DeviceReadinessIndexkpii = abs((KPIiMeasured@Dayx−
KPIiBM)/(KPIiAcceptance− KPIiBM))
} else {DeviceReadinessIndexkpii =0}
}

Once the model computer has computed a DRI value for a particular KPI i, the model computer 602 can compute t_{KPI} and days to market for KPI i.

In a non-limiting implementation, t_{KPI} and days to market for KPI i may be computed as:

```
for kpi from 1 to i
{
  ${ReadinessIndex}_{KPI} = \{ \begin{matrix}\vert \frac{{KPI}_{Measured @ Dayt} - {KPI}_{BM}}{{KPI}_{Acceptance} - {KPI}_{BM}} \vert when {KPI}_{Dayt} \geq {KPI}_{BM} \\ 0 when {KPI}_{Dayt} < {KPI}_{BM}\end{matrix}$
      ${t}_{KPI} = 91 - \frac{ln ( \frac{1}{{RI}_{KPI}} - 1 )}{0.05776}$
    TimetoMarket_{KPI} = Dayx_{KPI} + (182 − t_{KPI})
  }
```

Once the model computer 602 has computed, t_{KPI} and days to market for KPI i, the model computer 602 can select a maximum amount of time to market for kpi 1 to i (Cannikin Law-Bucket effect.)

In a non-limiting implementation, the DRI value may be computed as:

```
for kpi from 1 to i
    {
TimetoMarket = Max{TimetoMarket_{KPIi}} = Max{Dayx_{KPIi} + (182 −
t_{KPIi})}
    }
```

The disclosed implementations leverage novel data analytics algorithms to forecast device readiness, estimate time to market for a pre-launched device and compute a maturity curve for a pre-launched device. For example, the disclosed implementations initialize a model of device maturity with a neutral curve-sigmoid curve. The shape of the curve can be updated to best fit a real-world or true operational scenario of a given pre-launched device. The maturity curve can be a dynamically learned curve to reflect the extent to which a given device is mature for market release or sale. The disclosed implementations can traverse measured KPIs for a device (e.g., the mobile station 13a) and determine the device's readiness by identifying a KPI which consumes the most time to pass a KPI threshold value. The disclosed implementations also incorporate Cannikin Law-Bucket effect when identifying a KPI which consumes the most time to pass a KPI threshold value. The Cannikin Law-Bucket effect is a real world scenario where a shortest plank in a bucket is used to determine how much water is in the bucket. In a similar manner, a KPI with least readiness represents the overall readiness for a pre-launched device.

The disclosed implementations determine an optimal (or best) curve to fit device readiness for a given device. The best curve to fit device readiness can be determined using a maximum value of DRI, a curvature of the sigmoid curve, and an inflection point of the sigmoid curve.

Device readiness may be evaluated for market for devices including touch screen type mobile stations as well as to non-touch type mobile stations. Hence, our simple example shows the mobile station (MS) 13a as a non-touch type mobile station and shows the mobile station (MS) 13 as a touch screen type mobile station. Implementation of the on-line device readiness evaluation service may involve at least some execution of programming in the mobile stations as well as implementation of user input/output functions and data communications through the network 15, from the mobile stations.

Those skilled in the art presumably are familiar with the structure, programming and operations of the various type of mobile stations. However, for completeness, it may be useful to consider the functional elements/aspects of two exemplary mobile stations 13a and 13b, at a high-level.

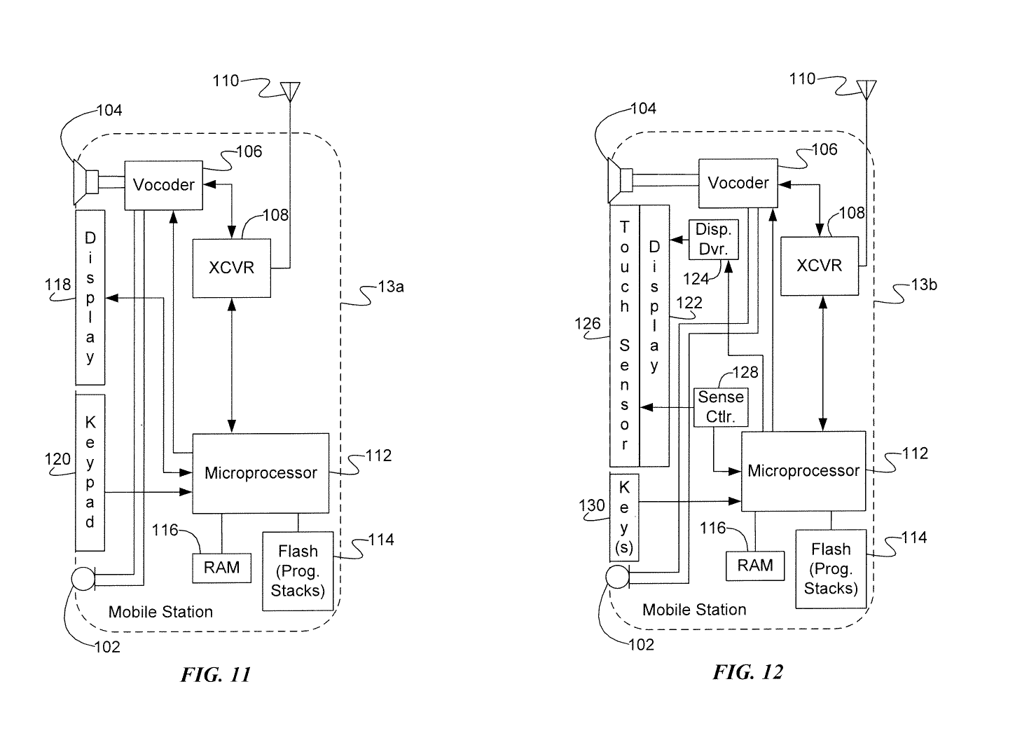

For purposes of such a discussion, FIG. 11 provides a block diagram illustration of an exemplary non-touch type mobile station 13a. Although the mobile station 13a may be a smart-phone or may be incorporated into another device, such as a personal digital assistant (PDA) or the like, for discussion purposes, the illustration shows the mobile station 13a is in the form of a handset. The handset embodiment of the mobile station 13a functions as a normal digital wireless telephone station. For that function, the station 13a includes a microphone 102 for audio signal input and a speaker 104 for audio signal output. The microphone 102 and speaker 104 connect to voice coding and decoding circuitry (vocoder) 106. For a voice telephone call, for example, the vocoder 106 provides two-way conversion between analog audio signals representing speech or other audio and digital samples at a compressed bit rate compatible with the digital protocol of wireless telephone network communications or voice over packet (Internet Protocol) communications.

For digital wireless communications, the handset 13a also includes at least one digital transceiver (XCVR) 108. Today, the handset 13a would be configured for digital wireless communications using one or more of the common network technology types. The concepts discussed here encompass embodiments of the mobile station 13a utilizing any digital transceivers that conform to current or future developed digital wireless communication standards. The mobile station 13a may also be capable of analog operation via a legacy network technology.

The transceiver 108 provides two-way wireless communication of information, such as vocoded speech samples and/or digital information, in accordance with the technology of the network 15. The transceiver 108 also sends and receives a variety of signaling messages in support of the various voice and data services provided via the mobile station 13a and the communication network. Each transceiver 108 connects through RF send and receive amplifiers (not separately shown) to an antenna 110. The transceiver may also support various types of mobile messaging services, such as short message service (SMS), enhanced messaging service (EMS) and/or multimedia messaging service (MMS).

The mobile station 13a includes a display 118 for displaying messages, menus or the like, call related information dialed by the user, calling party numbers, etc., including information related to evaluating device readiness. A keypad 120 enables dialing digits for voice and/or data calls as well as generating selection inputs, for example, as may be keyed-in by the user based on a displayed menu or as a cursor control and selection of a highlighted item on a displayed screen. The display 118 and keypad 120 are the physical elements providing a textual or graphical user interface. Various combinations of the keypad 120, display 118, microphone 102 and speaker 104 may be used as the physical input output elements of the graphical user interface (GUI), for multimedia (e.g., audio and/or video) communications. Of course other user interface elements may be used, such as a trackball, as in some types of PDAs or smart phones.

In addition to normal telephone and data communication related input/output (including message input and message display functions), the user interface elements also may be used for display of menus and other information to the user and user input of selections, including any needed during evaluating device readiness.

A microprocessor 112 serves as a programmable controller for the mobile station 13a, in that it controls all operations of the mobile station 13a in accord with programming that it executes, for all normal operations, and for operations involved in the evaluating device readiness under consideration here. In the example, the mobile station 13a includes flash type program memory 114, for storage of various “software” or “firmware” program routines and mobile configuration settings, such as mobile directory number (MDN) and/or mobile identification number (MIN), etc. The mobile station 13a may also include a non-volatile random access memory (RAM) 116 for a working data processing memory. Of course, other storage devices or configurations may be added to or substituted for those in the example. In a present implementation, the flash type program memory 114 stores firmware such as a boot routine, device driver software, an operating system, call processing software and vocoder control software, and any of a wide variety of other applications, such as client browser software and short message service software. The memories 114, 116 also store various data, such as telephone numbers and server addresses, downloaded data such as multimedia content, and various data input by the user. Programming stored in the flash type program memory 114, sometimes referred to as “firmware,” is loaded into and executed by the microprocessor 112.

As outlined above, the mobile station 13a includes a processor, and programming stored in the flash memory 114 configures the processor so that the mobile station is capable of performing various desired functions, including in this case the functions involved in the technique for evaluating device readiness.

For purposes of such a discussion, FIG. 12 provides a block diagram illustration of an exemplary touch screen type mobile station 13b. Although possible configured somewhat differently, at least logically, a number of the elements of the exemplary touch screen type mobile station 13b are similar to the elements of mobile station 13a, and are identified by like reference numbers in FIG. 12. For example, the touch screen type mobile station 13b includes a microphone 102, speaker 104 and vocoder 106, for audio input and output functions, much like in the earlier example. The mobile station 13b also includes at least one digital transceiver (XCVR) 108, for digital wireless communications, although the handset 13b may include an additional digital or analog transceiver. The concepts discussed here encompass embodiments of the mobile station 13b utilizing any digital transceivers that conform to current or future developed digital wireless communication standards. As in the station 13a, the transceiver 108 provides two-way wireless communication of information, such as vocoded speech samples and/or digital information, in accordance with the technology of the network 15. The transceiver 108 also sends and receives a variety of signaling messages in support of the various voice and data services provided via the mobile station 13b and the communication network. Each transceiver 108 connects through RF send and receive amplifiers (not separately shown) to an antenna 110. The transceiver may also support various types of mobile messaging services, such as short message service (SMS), enhanced messaging service (EMS) and/or multimedia messaging service (MMS).

As in the example of station 13a, a microprocessor 112 serves as a programmable controller for the mobile station 13b, in that it controls all operations of the mobile station 13b in accord with programming that it executes, for all normal operations, and for operations involved in evaluating device readiness under consideration here. In the example, the mobile station 13b includes flash type program memory 114, for storage of various program routines and mobile configuration settings. The mobile station 13b may also include a non-volatile random access memory (RAM) 116 for a working data processing memory. Of course, other storage devices or configurations may be added to or substituted for those in the example. Hence, outlined above, the mobile station 13b includes a processor, and programming stored in the flash memory 114 configures the processor so that the mobile station is capable of performing various desired functions, including in this case the functions involved in the technique for evaluating device readiness.

In the example of FIG. 11, the user interface elements included a display and a keypad. The mobile station 13b may have a limited number of key 130, but the user interface functions of the display and keypad are replaced by a touchscreen display arrangement. At a high level, a touchscreen display is a device that displays information to a user and can detect occurrence and location of a touch on the area of the display. The touch may be an actual touch of the display device with a finger, stylus or other object, although at least some touchscreens can also sense when the object is in close proximity to the screen. Use of a touchscreen display as part of the user interface enables a user to interact directly with the information presented on the display.

Hence, the exemplary mobile station 13b includes a display 122, which the microprocessor 112 controls via a display driver 124, to present visible outputs to the device user. The mobile station 13b also includes a touch/position sensor 126. The sensor 126 is relatively transparent, so that the user may view the information presented on the display 122. A sense circuit 128 sensing signals from elements of the touch/position sensor 126 and detects occurrence and position of each touch of the screen formed by the display 122 and sensor 126. The sense circuit 128 provides touch position information to the microprocessor 112, which can correlate that information to the information currently displayed via the display 122, to determine the nature of user input via the screen.

The display 122 and touch sensor 126 (and possibly one or more keys 130, if included) are the physical elements providing the textual and graphical user interface for the mobile station 13b. The microphone 102 and speaker 104 may be used as additional user interface elements, for audio input and output, including with respect to some functions related to evaluating device readiness for market.

The structure and operation of the mobile stations 13a and 13b, as outlined above, were described to by way of example, only.

As shown by the above discussion, functions relating to evaluating device readiness, via a graphical user interface of a mobile station may be implemented on computers connected for data communication via the components of a packet data network, operating as an analytics engine of FIG. 1. Although special purpose devices may be used, such devices also may be implemented using one or more hardware platforms intended to represent a general class of data processing device commonly used to run “server” programming so as to implement evaluating device readiness for market discussed above, albeit with an appropriate network connection for data communication.

As known in the data processing and communications arts, a general-purpose computer typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data, e.g. files used for evaluating device readiness. The software code is executable by the general-purpose computer that functions as the analytics engine and/or that functions as a mobile terminal device. In operation, the code is stored within the general-purpose computer platform. At other times, however, the software may be stored at other locations and/or transported for loading into the appropriate general-purpose computer system. Execution of such code by a processor of the computer platform enables the platform to implement the methodology for evaluating device readiness, in essentially the manner performed in the implementations discussed and illustrated herein.

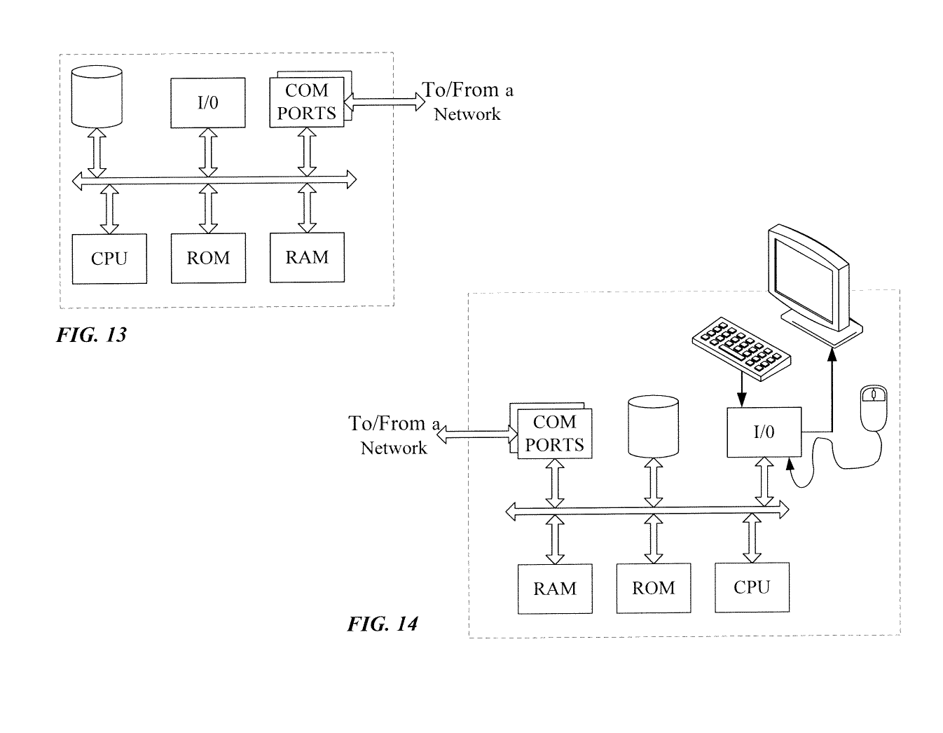

FIGS. 13 and 14 provide functional block diagram illustrations of general purpose computer hardware platforms. FIG. 13 illustrates a network or host computer platform, as may typically be used to implement a server. FIG. 14 depicts a computer with user interface elements, as may be used to implement a personal computer or other type of work station or terminal device, although the computer of FIG. 13 may also act as a server if appropriately programmed. It is believed that those skilled in the art are familiar with the structure, programming and general operation of such computer equipment and as a result the drawings should be self-explanatory.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature, and it is presumed that those skilled in the art are adequately familiar therewith. Of course, the server functions may be implemented in a distributed fashion on a number of similar platforms, to distribute the processing load.

A computer type user terminal device, such as a PC or tablet computer, similarly includes a data communication interface CPU, main memory and one or more mass storage devices for storing user data and the various executable programs. A mobile device type user terminal may include similar elements, but will typically use smaller components that also require less power, to facilitate implementation in a portable form factor. The various types of user terminal devices will also include various user input and output elements. A computer, for example, may include a keyboard and a cursor control/selection device such as a mouse, trackball, joystick or touchpad; and a display for visual outputs. A microphone and speaker enable audio input and output. Some smartphones include similar but smaller input and output elements. Tablets and other types of smartphones utilize touch sensitive display screens, instead of separate keyboard and cursor control elements. The hardware elements, operating systems and programming languages of such user terminal devices also are conventional in nature, and it is presumed that those skilled in the art are adequately familiar therewith.

Hence, aspects of the methods of evaluating device readiness outlined above may be embodied in programming. Program aspects of the technology may be thought of as “products” or “articles of manufacture” typically in the form of executable code and/or associated data that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the wireless network provider into the computer platform of the analytics engine. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the analytics engine, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
initializing, using one or more processors, a model representing a device's readiness for market based on one or more key performance indicators (KPIs) of the device, wherein the model is represented by a curve;
computing, using the one or more processors, differences between measured value of KPIs of the device and values of KPIs fitted to the curve;
identifying, using the one or more processors, an inflection point of the curve based on the computed differences, wherein the inflection point represents a point on the curve at which curvature of the curve changes sign;
interpreting, using the one or more processors, the shape of the curve based on the identified inflection point, a readiness index and the curvature of the curve, wherein the device readiness index is based at least on a KPI that takes the most amount of time relative to other KPIs to cross a manufacturing performance threshold represented in the curve;
determining, using the one or more processors, a state of readiness of the device based on the interpreted shape of the curve; and
based on the determined state of readiness of the device, providing, using the one or more processors, one or more instructions to supply chain components to adjust supply chain operations.

2. The method of claim 1, further comprising adjusting, using the one or more processors, the initialized model including the curve to conform to the state of readiness of the device, wherein the adjusting is triggered by conditions including a mean error rate of the KPIs.

3. The method of claim 1, further comprising:
traversing, using the one or more processors, each measured KPI for the device, to identify the KPI that consumes most time to cross the manufacturing performance threshold represented in the curve; and
generating, using the one or more processors, a report indicating the identified KPI.

4. The method of claim 1, further comprising:
classifying, using the one or more processors, a manufacturer of the device into an operational performance category based on the interpreted shape of the curve; and
generating, using the one or more processors, a report indicating the operational performance category.

5. The method of claim 1, further comprising:
when the interpreted shape is determined to be a concaved downward logarithmic curve, generating a report indicating that a manufacturer of the device attempts to resolve performance issues with the device at an early stage in a manufacturing process.

6. The method of claim 1, further comprising when the interpreted shape is determined to be a concaved downward polynomial curve, generating a report indicating that a manufacturer of the device attempts to resolve performance issues close to a cut-off release date in a manufacturing process.

7. The method of claim 1, further comprising when the interpreted shape is determined to be an s-curve, generating a report indicating that a manufacturer of the device attempts to resolve performance issues in close accordance with a pre-determined schedule prior to a cut-off release date in a manufacturing process.

8. An analytics engine comprising:
a communication interface configured to enable communication via a mobile network;
a processor coupled with the communication interface;
a storage device accessible to the processor; and
an executable program in the storage device, wherein execution of the program by the processor configures the server to perform functions, including functions to:
initialize a model representing a device's readiness for market based on one or more key performance indicators (KPIs) of the device, wherein the model is represented by a curve;
compute differences between measured value of KPIs of the device and values of KPIs fitted to the curve;
identify an inflection point of the curve based on the computed differences, wherein the inflection point represents a point on the curve at which curvature of the curve changes sign;
interpret the shape of the curve based on the identified inflection point, a readiness index and the curvature of the curve, wherein the device readiness index is based at least on a KPI that takes the most amount of time relative to other KPIs to cross a manufacturing performance threshold represented in the curve;
determine a state of readiness of the device based on the interpreted shape of the curve; and
based on the determined state of readiness of the device, provide one or more instructions to supply chain components to adjust supply chain operations.

9. The analytics engine of claim 8, wherein execution of the program by the processor configures the server to perform functions, including functions to:
adjust the initialized model including the curve to conform to the state of readiness of the device, wherein the adjusting is triggered by conditions including a mean error rate of the KPIs.

10. The analytics engine of claim 8, wherein execution of the program by the processor configures the server to perform functions, including functions to:
traverse each measured KPI for the device to identify the KPI that consumes most time to cross the manufacturing performance threshold represented in the curve; and
generate a report indicating the identified KPI.

11. The analytics engine of claim 8, wherein execution of the program by the processor configures the server to perform functions, including functions to:
classify a manufacturer of the device into an operational performance category based on the interpreted shape of the curve; and
generate a report indicating the operational performance category.

12. The analytics engine of claim 8, wherein execution of the program by the processor configures the server to perform functions, including functions to:
when the interpreted shape is determined to be a concaved downward logarithmic curve, generate a report indicating that a manufacturer of the device attempts to resolve performance issues with the device at an early stage in a manufacturing process.

13. The analytics engine of claim 8, wherein execution of the program by the processor configures the server to perform functions, including functions to:
when the interpreted shape is determined to be a concaved downward polynomial curve, generate a report indicating that a manufacturer of the device attempts to resolve performance issues close to a cut-off release date in a manufacturing process.

14. The analytics engine of claim 8, wherein execution of the program by the processor configures the server to perform functions, including functions to:
when the interpreted shape is determined to be an s-curve, generate a report indicating that a manufacturer of the device attempts to resolve performance issues in close accordance with a pre-determined schedule prior to a cut-off release date in a manufacturing process.

15. A non-transitory computer-readable medium comprising instructions which, when executed by one or more computers, cause the one or more computers to:
initialize a model representing a device's readiness for market based on one or more key performance indicators (KPIs) of the device, wherein the model is represented by a curve;
compute differences between measured value of KPIs of the device and values of KPIs fitted to the curve;
identify an inflection point of the curve based on the computed differences, wherein the inflection point represents a point on the curve at which curvature of the curve changes sign;
interpret the shape of the curve based on the identified inflection point, a readiness index and the curvature of the curve, wherein the device readiness index is based at least on a KPI that takes the most amount of time relative to other KPIs to cross a manufacturing performance threshold represented in the curve;
determine a state of readiness of the device based on the interpreted shape of the curve; and
based on the determined state of readiness of the device, provide one or more instructions to supply chain components to adjust supply chain operations.

16. The computer-readable medium of claim 15 wherein initialization of the model representing a device's readiness includes initializing a neutral sigmoid curve.

17. The computer-readable medium of claim 15 wherein identification of the inflection point of the curve at which curvature of the curve changes sign comprises:
identifying a point where a second derivative of a function representing the curve changes sign.

18. The computer-readable medium of claim 15 further comprising instructions which, when executed by the one or more computers, cause the one or more computers to:
adjust the initialized model including the curve to conform to the state of readiness of the device, wherein the adjusting is triggered by conditions including a mean error rate of the KPIs.

19. The computer-readable medium of claim 15 further comprising instructions which, when executed by the one or more computers, cause the one or more computers to:
traverse each measured KPI for the device to identify the KPI that consumes most time to cross the manufacturing performance threshold represented in the curve; and
generate a report indicating the identified KPI.

20. The computer-readable medium of claim 15 further comprising instructions which, when executed by the one or more computers, cause the one or more computers to:
classify a manufacturer of the device into an operational performance category based on the interpreted shape of the curve; and
generate a report indicating the operational performance category.
